(19) United States
(12) Patent Application Publication
(10) Pub. No.: US 2006/0198759 A1
(43) Pub. Date: Sep. 7, 2006

(54) Universal test-tube rack for chemical and biochemical sample preparation

(76) Inventors: Alexander M. Shneider, Stoughton, MA (US); Yakov Katsman, Stoughton, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/071,008

(22) Filed: Mar. 3, 2005

(51) Int. Cl. B01L 9/00

(52) U.S. Cl. 422/72; 422/104

(57) ABSTRACT

A universal test-tube rack is configured for mounting on each of a plurality of apparatus for sample preparation. A centrifugal spinning vortex induction apparatus includes a combination centrifuge/vortex including a motor with a rotational drive system on which the portable test-tube rack can be mounted for rotation and oscillation. A feed station, flotation ring and holder can also be provided, each serving as a mount for the test-tube rack, wherein the test-tube rack can be proceed from station to station with the test tubes and samples remaining in the rack and with the relative configuration and orientation of the test tubes remaining substantially the same throughout the process.

### RELATED APPLICATION

This application is a continuation-in-part of prior U.S. application Ser. No. [serial number to be cited after assignment of same by USPTO], entitled, “Apparatus and Methods for Chemical and Biochemical Sample Preparation,” filed on Feb. 7, 2005, by this firm under attorney docket number 25955-004, the entire teachings of which are incorporated herein by reference.

### BACKGROUND

In chemical and biochemical sample preparation and analytical procedures, a variety of apparatus and tools are used, including centrifuges, pipettors, test tubes (e.g., Microfuge™ or Eppendorf™-type tubes), temperature-controlled baths, and vortexing machines. All of these apparatus are used for routine, daily procedures, such as sample concentration, extraction, amplification using the polymerase chain reaction, and so forth.

In these routine procedures, microcentrifuges, such as the Microfuge™ 22R or Eppendorf™ 5415D microcentrifuge, are used to spin down samples in micro tubes having, e.g., 0.2, 0.5, 1.5 or 2.5 ml capacities. The 0.2 and 0.5 ml sizes are often used in polymerase chain reaction (PCR) experiments. Stand-alone vortexing machines, such as the Vortex Genie mixer (Scientific Industries, Inc.), for mixing liquid samples in individual sample tubes are used to combine and thoroughly mix the tube contents at various points in the procedure. However, such standalone vortexing apparatus require manual involvement (i.e., manually pressing each tube into a rubber cup to engage an eccentric motor) in the mixing of each tube. None of the multiple attempts to mix the test tubes contained in a test-tube rack gave an acceptable level of mixing. Individual application of the tubes to vortexing machine takes a lot of time and can create physical discomfort for a researcher exposed to extensive vibration. In a clinical analysis, these limitations could lead to patients suffering from a wrong diagnosis.

Another problem with manual sample-preparation procedures is simple human error. Multiple samples are often processed on a given day. In the processing of the sample, microcentrifuge tubes are independently filled, vortexed, placed into and out of racks, opened, closed, and placed into and out of the microcentrifuge. Each operation or transfer point provides an opportunity for misidentifying tubes, moving them to the wrong position, transferring liquid out of the wrong tube or dispensing liquids or reagents into the wrong tube. These errors result in wasted time, results, manpower and money.

### SUMMARY

Disclosed herein is a universal test-tube rack in which sample-filled test tubes can be contained throughout a series of procedures for chemical or biochemical sample preparation. The sample preparation procedures can include centrifugation, sample feeding/extraction, mixing, incubation and storage. Whereas test tubes have been individually transferred between various apparatus for performing these actions in previous methods, the universal test-tube rack removes the need for individual handling of the test tubes when transferring the test tubes among the apparatus between process steps. The test-tube rack defines a plurality of apertures (into which the test tubes can be mounted) positioned substantially equidistant about an axis of rotation at the center of the test-tube rack and about which the test-tube rack is substantially symmetrical.

The apertures are sloped such that when the test tubes are mounted in the rack's apertures, the longitudinal axis of each test tube is non-parallel with the axis of rotation when the test tube is mounted in the orifice. In particular embodiments, the test tubes are microcentrifuge tubes of standard sizes (e.g., 0.2, 0.5, 1.5 or 2.5 ml capacities). These test tubes are well known in the art.

The test-tube rack is further designed so that it can be removably mounted on each apparatus that is used for sample preparation. In one embodiment, a combined centrifugal spinning vortex induction apparatus includes a motorized rotational drive system adapted to operate both in a rotationally spinning mode and in an oscillating mode. The test-tube rack can be mounted to the motorized rotational drive system as a rotor, thereby enabling the motorized rotational drive system to rotate the test-tube rack about its axis.

The centrifugal spinning vortex induction apparatus also includes a control panel that enables selection of either a centrifuge mode or a mixing mode. When the centrifuge mode is selected, the rotor rotates continuously and uni-directionally about its axis so as to separate components in the test-tube samples via the well-known practice of centrifuging. When the mixing mode is selected, the samples are mixed, e.g., by oscillating the rotor back and forth to generate vortices in the samples.

A feed station can also be provided, wherein the feed station also has a rotor configured to allow the universal test-tube rack to be mounted thereon for rotation about its axis. Because the feed station accommodates the test-tube rack, the operator can transfer the test tubes to and from the feed station without having to transfer the tubes from the rack. The feed station features a rotor having a platform for mating with the test-tube rack and a ratcheting mechanism that allows the user to incrementally rotate the test-tube rack from one detent to the next and liquid can be added or removed from a sample with each incremental rotation so that samples may be manipulated without having to remove the test tubes from the rack. The feed station can further include the following: a pipette positioned for liquid addition or removal into a test tube in the test-tube rack; a motor coupled with the rotor to rotate the rotor; and electronic controls for causing a rotary-drive motor to repeatedly and incrementally rotate the rotor via a fixed angle of rotation and for generating a dispersion from the pipette with each rotation.

In alternative embodiments, the feed station can also include electronic controls for rotating and/or oscillating the test-tube rack for performing centrifuging and/or mixing operations. In which case, the combined centrifugal spinning vortex induction apparatus would not be needed.

A flotation ring can also be provided as an element of the apparatus. The rack and the ring are sized and shaped such that the test-tube rack can be mounted atop the ring and placed in a temperature-controlled liquid bath for heating or cooling the samples during, e.g., an incubation stage. The ring keeps lower parts of the test tubes immersed in the liquid, while keeping the top openings of the test tubes above the bath surface. Alternatively, the design of the test-tube rack can provide a flotation capability (e.g., by including floatation material, such as styrofoam, or by including a hollow chamber) so that the test-tube rack will float in the bath without needing a separate flotation element to prevent sinking of the rack.

Further still, a holder can be provided upon which the test-tube rack can be mounted with sample-filled test tubes inserted for storage. The holder and the rack are respectively sized and shaped such that the rack can be securely mounted on the holder. In particular embodiments, the holder is of a design that allows a plurality of holders, with a rack mounted on each, to be stacked atop one another.

Accordingly, each of the above components is part of an integrated system that enables the test-tube rack to be mounted on each of the other components and passed through a sample preparation procedure (e.g., centrifuging, component addition/removal, mixing, controlled heating/cooling, and storage) without there being any need to remove any of the test tubes from the rack over the course of the procedure.

These apparatus and methods can accordingly reduce the time for and the error in sample preparation and analytical procedures. Because the components of the system are adapted to work cooperatively with one another, the value of the system to the scientist is increased.

### BRIEF DESCRIPTION OF THE DRAWINGS

In the accompanying drawings, described below, like reference characters refer to the same or similar parts throughout the different views. The drawings are not necessarily to scale, emphasis instead being placed upon illustrating particular principles of the methods and apparatus characterized in the Detailed Description.

FIG. 1 is a perspective view of a centrifugal spinning vortex induction apparatus with a sample-filled test-tube rack mounted thereon.

FIG. 2 is a cross-sectional side view of the centrifugal spinning vortex induction apparatus.

FIG. 3 is a cross-sectional side view of a centrifugal spinning vortex induction apparatus that further comprises a heavy rotor upon which the test-tube rack is mounted.

FIG. 4 is a cross-sectional side view of a centrifugal spinning vortex induction apparatus that includes a rotor provided with alternative means for mounting the test-tube rack thereon.

FIG. 5 is a cross-sectional side view of a traditional centrifuge, wherein the test-tube rack is mounted thereon via plungers passing through the rack and into the cavities in the centrifuge rotor that are intended for test tubes.

FIG. 6 is a cross-sectional side view of a traditional centrifuge, wherein an adapter is mounted atop the centrifuge rotor, and the test-tube rack is mounted atop the adapter.

FIG. 7 is a perspective view of a feed station.

FIG. 8 is a perspective view of the feed station with the test-tube rack mounted thereon.

FIG. 9 is a view of a flotation device from above.

FIG. 10 is a perspective view of the flotation device with the test-tube rack mounted thereon.

FIG. 11 is a perspective view of a holder for the test-tube rack.

FIG. 12 is a perspective view of the holder for the test-tube rack with the test-tube rack mounted therein.

FIG. 13 is a perspective side view of two of the holders vertically stacked with the test-tube rack mounted in the lower holder.

FIG. 14 is a cross-sectional side view of an alternative holder design, wherein two holders and racks are vertically stacked.

FIG. 15 is a sectional view of a rigid test-tube rack.

FIG. 16 is a sectional view of the rigid test-tube rack of FIG. 15 with test tubes inserted in the rack's apertures.

FIG. 17 is a sectional view of a rigid test-tube rack with integrated test tubes.

FIG. 18 is a sectional view of a flexible test-tube rack.

FIG. 19 is a sectional view of the flexible test-tube rack of FIG. 18 with test tubes inserted in the rack's apertures.

FIG. 20 is a sectional view of a flexible test-tube rack with integrated test tubes.

FIG. 21 is an illustration of a test-tube rack having a rectangular configuration in a plane of its greatest dimensions.

FIG. 22 is an illustration of the flexible test-tube rack of FIG. 20, wherein the rack is flexed.

FIG. 23 is an illustration from above of a flexible test-tube rack comprising flexible strips.

FIG. 24 is an illustration from above of the flexible test-tube rack of FIG. 23, wherein the strips are flexed upward.

FIG. 25 is a sectional view of a flexible test-tube rack having reinforced sections surrounding the apertures.

FIG. 26 is a sectional view of another embodiment of a flexible test-tube rack having reinforced sections surrounding the apertures.

FIG. 27 is a sectional view of a flexible test-tube rack for use with a split rotor.

FIG. 28 is a sectional view of a rigid test-tube rack for use with a split rotor.

FIG. 29 is a sectional view of a flexible test-tube rack with integrated test tubes for use with a split rotor.

FIG. 30 is a sectional view of a rigid test-tube rack with integrated test tubes for use with a split rotor.

FIG. 31 is a sectional view of a flexible test-tube rack mounted in a flexed position in a split rotor.

FIG. 32 is a sectional view of a rigid test-tube rack mounted in a split rotor.

FIG. 33 is a sectional view of a flexible test-tube rack having integrated test tubes mounted in a flexed position in a split rotor.

FIG. 34 is a sectional view of a rigid test-tube rack having integrated test tubes mounted in a split rotor.

### DETAILED DESCRIPTION

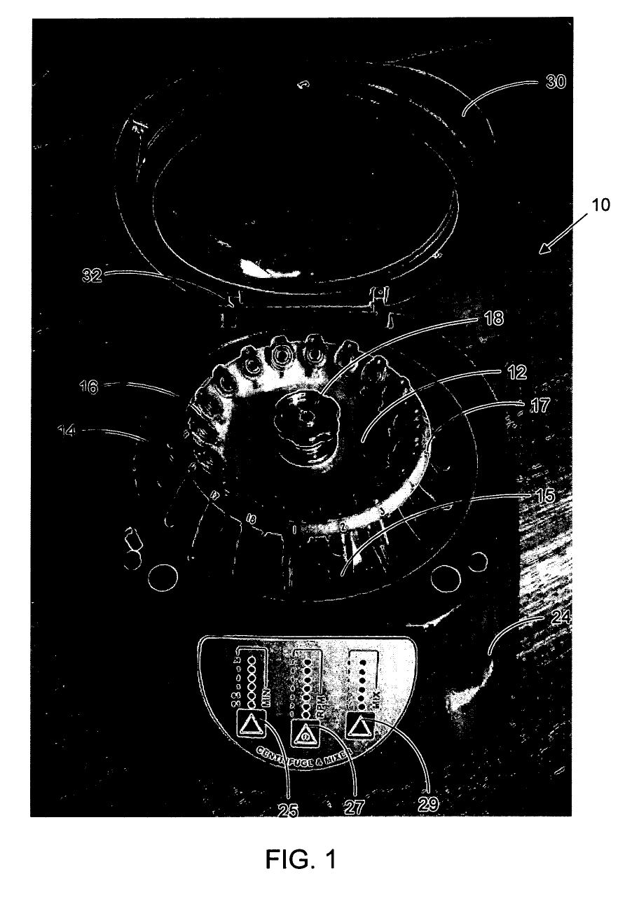

The test-tube rack 12 is shown mounted atop an embodiment of a centrifugal spinning vortex induction apparatus 10 in FIG. 1. Test tubes 14 (e.g., 1.5 milEppendorf tubes) are mounted in eighteen apertures 16 defined around the periphery of the test-tube rack 12, which has an outer diameter of about 12 cm in this embodiment. Each of the apertures 16, and hence, each of the test tubes 14 is a fixed distance from the center of the test-tube rack 12, which serves as its axis of rotation. The rack 12 can be any of a variety of sizes, depending up on the desired test tube capacity of the racks. The rack in FIG. 1 is configured to hold 18 test tubes; though, a larger rack with additional apertures for holding, e.g., 24 test tubes can alternatively be provided and processed in the same manner. Further, indicators 17 (e.g., numbers) can be printed adjacent to the apertures 16 for purposes of labeling and tracking the test tube 14 mounted in each.

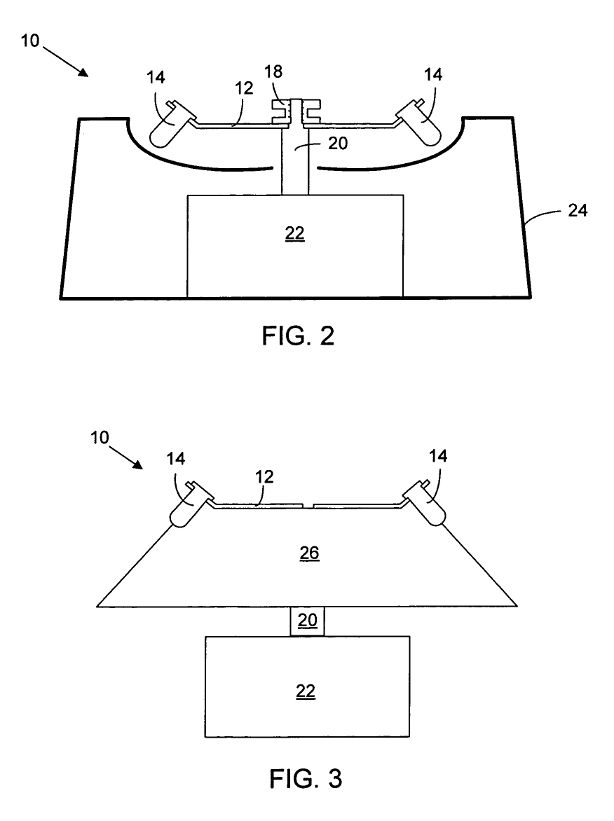

The test-tube rack 12 is mounted to a rotational drive mechanism including a rotary motor 22 and a drive shaft 20, as shown in FIG. 2, which thereby enables the motor 22 to spin the rack 12 about a vertical axis (as illustrated in FIG. 2). The surfaces of the rack 12 that define the apertures 16 are sloped outwardly from top to bottom such that the longitudinal axis of the test tubes 14 angle radially away from the rack's axis of rotation (i.e., with the bottom of each test tube being further from the rack's central vertical axis of rotation than is the top of the tube). The test-tube rack 12 can be formed of plastic or any other material that can support the weight of the sample-filled rack 12 without substantially deforming and that can withstand the rigors of repeated centrifuging and mixing procedures. A latching mechanism 18 (e.g., in the form of an internally threaded grippable ring that can be screwed onto an externally treaded rod extending from the drive shaft) is provided to removably lock the test-tube rack 12 onto the drive shaft 20. Additionally, a cover 30 is joined to the shell 24 via hinges 32 and is downwardly pivotable to enclose the test-tube rack 12 and test tubes 14 within a void space between the cover and 30 and the base shell 24. The cover 30 is ordinarily closed during operation of the centrifugal spinning vortex induction apparatus 10.

The centrifugal spinning vortex induction apparatus 10 can be set to operate either as a centrifuge or as a mixer (e.g., vortex generator). In “centrifuge” mode, the motor continuously rotates the drive shaft 20 and the test-tube rack 12 about the axis of the drive shaft 20. In “vortex” mode, the test-tube rack 12 is reciprocated about its central axis (i.e., the axis of the drive shaft) with an angular travel of 1° to 45° for the test tubes about the axis between each reversal of direction.

The motor 22 is housed in a shell 24 that serves as the base of the apparatus 10. The motor 22 can have a speed range of 1,000 to 14,000 revolutions per minute and offers control capability. Examples of suitable motors include stepping motors in the 56Q series produced by Saehan Electronics Co., Ltd. (Ichon City, Korea). The motor 22 can be controlled via electronics in the shell that are coupled with the motor 22 and with operator controls 25, 27 and 29 embedded in the shell 24. Control element 25 allows the operator to set the time for centrifuging or mixing for one of several periods ranging from 3 seconds to 24 hours. Control element 27 allows the operator to select a centrifuge speed at one of several values in the range, e.g., from 1,000 to 14,000 revolutions per minute. Finally, control element 29 allows the operator to select a vortex/mixing rate, e.g., from 60 to 60,000 oscillations per minute. The operator accordingly can command the desired procedures by selecting both a time value as well as either a centrifuge speed or a vortex rate. In this embodiment, the control elements 25, 27 and 29 each include a push button and a light indicator, whereby higher levels are selected by repeatedly pushing the respective button, and an additional light is added with each level increase.

Electronic circuits lead from the control elements 25, 27 and 29 to operate the motor in accordance with the operator's selections. The control electronics can be coupled with a microcontroller (comprising a microprocessor and a computer-readable software medium storing software code on a chip) capable of controlling the speed, direction, cycles and time periods of industrial stepping motors per the operator's input. Examples of suitable microcontrollers are those in the model MB90F590 family of controllers produced by Fujitsu,. Ltd. (Tokyo, Japan).

As alternatives to the push-button controls, the rate of rotation or oscillation can be controlled via other mechanisms (e.g., via remote computer input and software control or via a hand-operated dial). Likewise, the on/off function can be manually controlled with a switch or via a software-generated timer among other mechanisms.

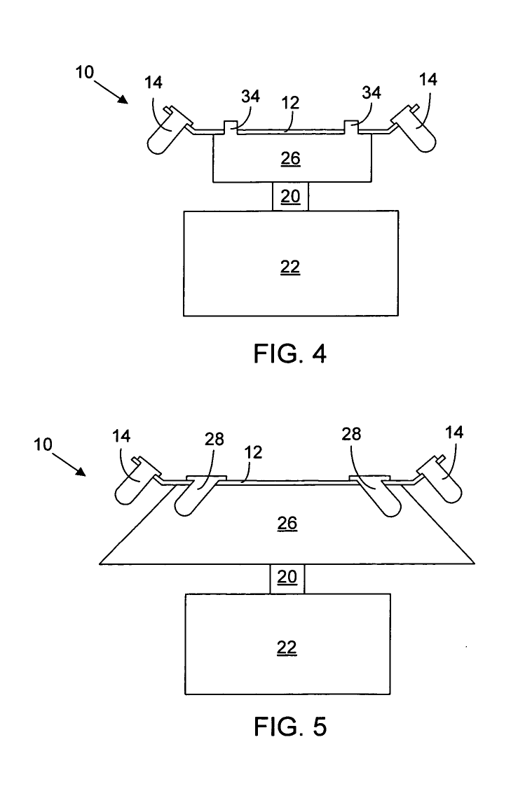

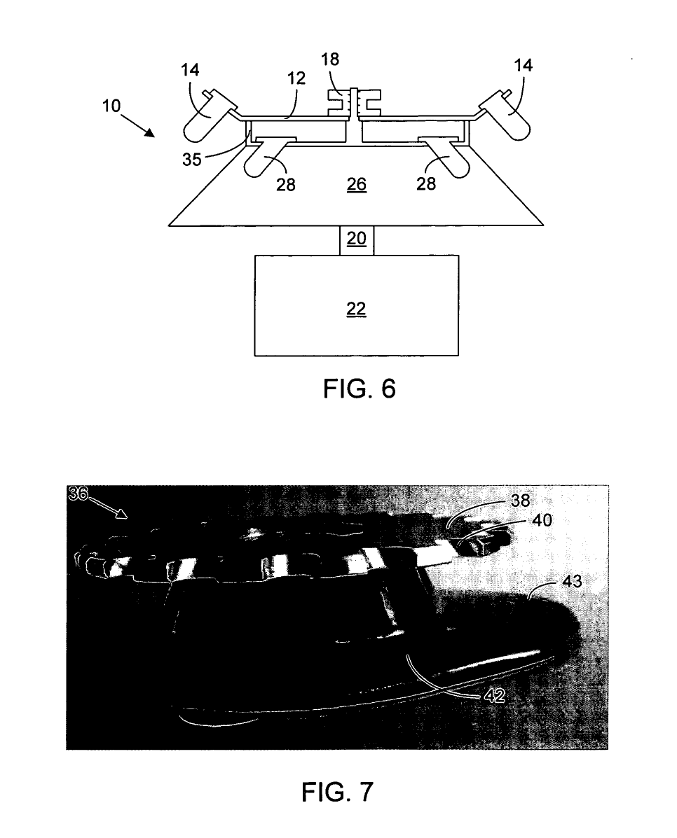

A variety of representative additional embodiments of the apparatus 10 are illustrated in FIGS. 3-6. These embodiments are briefly outlined, below, and then discussed in greater detail in the paragraphs that follow. As shown in the embodiments of FIGS. 3 and 4, the rack can be mounted to a special, massive rotor, which can be specific to this invention. In other embodiments, the rack is mounted to a conventional rotor (e.g., a conventional rotor into which test tubes are inserted in a centrifuge), though the test tubes can be mounted in apertures in the rack distinct from the cavities in the rotor into which the test tubes were conventionally inserted in previous methods. The rack can be directly mounted onto the rotor, as shown in the embodiment of FIG. 5; or an adapter can be mounted to the rotor and the rack can be mounted onto the adapter, as shown in the embodiment of FIG. 6. A variety of other means can also be is readily imagined for mounting the rack to the rotational drive mechanism of the apparatus 10.

Like the centrifugal spinning vortex induction apparatus of FIGS. 1 and 2, the apparatus of FIG. 3 includes a motor 22 and a rotary drive shaft 20 extending therefrom so as to be able to rotate or oscillate a test-tube rack 12 mounted on the apparatus 10 about a central axis. New in this embodiment, however, is a heavy rotor 26 upon which the test-tube rack 12 is mounted. The rotor 26 in this embodiment includes external semi-cylindrical grooves in which the test tubes 14 can rest when the rack 12 is mounted thereon.

The rotor 26, which can be formed, e.g., of steel or another metal, has a mass substantially greater than the combined mass of the sample-filled test tubes 14 and the rack 12. Consequently, the rotor 26 serves as a stabilizer that prevents the rotational unbalancing that may otherwise result during centrifuging or vortexing when the mass of the samples 15 in the test tubes 14 about the periphery of the rack 12 is unevenly dispersed. Because the mass of the rotor 26 is much greater than any difference in mass among the sample-filled test tubes 14, mass imbalances among the samples 15 are rendered incapable of compromising the apparatus' rotational stability (balance) during normal operation.

In the embodiment of the apparatus illustrated in FIG. 4, the rotor 26 includes a plurality of anchor posts 34 that can be used to secure corresponding apertures in the rack 12. This embodiment of the apparatus 10 can be used with a variety of different-sized racks 12, though all racks would share the same interior configuration of apertures to mate with the anchor posts 34 extending from the rotor 26. The mass of the rotor 26 would also help to stabilize the apparatus 10 during centrifuging and mixing, as in the embodiment of FIG. 3.

Yet another embodiment of a centrifugal spinning vortex induction apparatus 10 is illustrated in FIG. 5. The rotor 26 of this apparatus 10 is designed to hold fewer test tubes 14 than is the rack 12 mounted thereon. The rack 12 in this embodiment includes two concentric rings of apertures. Plungers 28 are inserted through the apertures in the inner ring to engage corresponding cavities (designed to hold test tubes) in the rotor 26. Accordingly, the size and shape of the surfaces of the plungers 28 that engage the cavities can mimic those of the test tubes 14. The actual sample-filled test tubes 14 are inserted into the outer ring of apertures in the rack 12. Consequently, the test-tube capacity of the apparatus 10 is effectively expanded by the rack 12.

In addition to the above embodiments, where the apparatus 10 is described as serving a dual purpose for centrifuging and mixing, any of the above-described apparatus 10 can alternatively be designed for the sole function of serving either as a centrifuge or as a vortex. Regardless of whether the apparatus 10 serves a dual- or single-function, the rack can be mounted on the apparatus 10 in the same manner and via the same mechanisms, as described above. For example, the apparatus 10 of FIG. 5 can be of an existing single-function centrifuge design. In such a case, where the apparatus 10 functions only as a centrifuge, mixing can be performed using another apparatus, such as an apparatus that shakes the test tubes 14 back and forth linearly rather than radially about an axis. However, these alternative mixing apparatus can likewise be designed to enable the universal rack 12 to be mounted thereon such that the test tubes 14 need not ever be removed from the rack 12 throughout each of the various stages of the sample-preparation procedure.

In another embodiment, illustrated in FIG. 6, an adapter 35 is mounted atop the rotor 26 of the apparatus 10 using plungers 28. The adapter 35 enables a rack 12 to be mounted thereon. Advantages of using the adapter 35 include the features of not requiring the rack 12, itself, to include provisions for accommodating mounting means, such as the plungers 28; racks 12 of a variety of sizes can be easily swapped on the adapter 35.

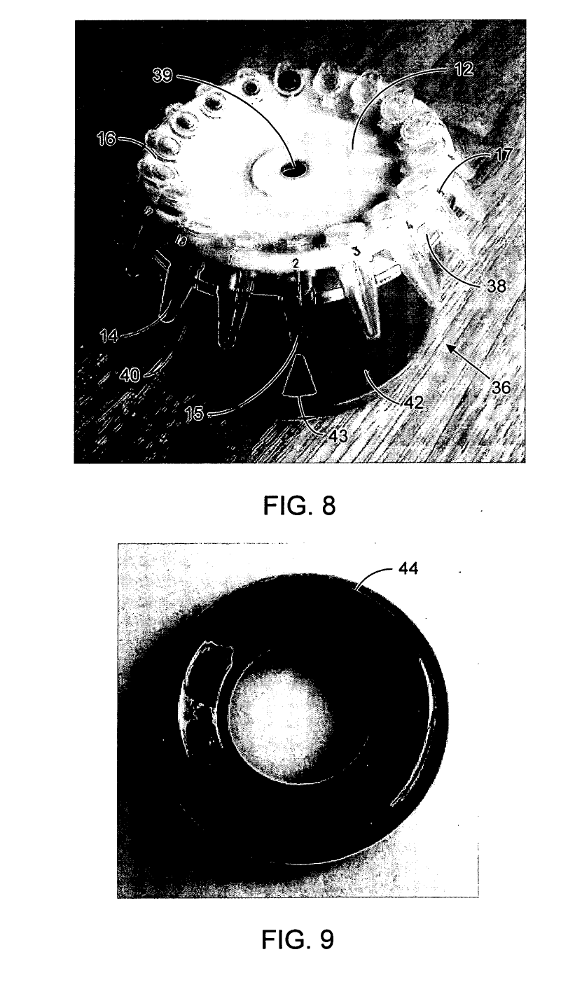

A feed station 36, illustrated in FIGS. 7 and 8, includes a rotor 38 that defines grooves 40 about its perimeter in which the test tubes 14 can rest when the rack 12 is mounted on top of the rotor 38. Optionally, the feed station 36 can include a post extending upward from the center of the rotor 38 such that the rack 12 (as shown in FIGS. 1 and 2) can be mounted thereon by passing the post through the rack's central aperture 39 as the rack 12 is lowered onto the rotor 38 of the feed station 36 in much the same way that the rack 12 is mounted on the centrifugal spinning vortex induction apparatus 10.

The rotor 38 is mounted on a base 42 for rotation about a vertical axis (extending orthogonally from the surface on which the base 42 is mounted). A rotary motor can be provided in the base 42, and the rotary motor can be programmed to rotate the rotor 38 such that the test tubes held in the rack advance clockwise or counter-clockwise by the distance between test tubes in the rack. The motor can be controlled via a microcontroller (including a microprocessor and software code stored on a computer-readable medium) to rotate the rotor by a fixed angle of rotation. Alternatively, the rotor 38 can be incrementally rotated about its axis by hand. A visible marker 43 is provided on the base 42 and can be aligned with a groove 40 in the rotor 38 such that the marker 43 will be aligned with successive test tubes in the rotor 38 as the rotor 38 is incrementally ratcheted around its central rotational axis.

A pipette (not shown) can be mounted with the outlet of the pipette positioned above the top opening of the test tube 14 that is aligned with (e.g., nearest to) the marker 43 so that the pipette can add a component to (or extract from) the sample 15 in the test tube 14. The pipette can be controlled to disperse a specified amount of the component into a test tube 14 at a fixed position between each incremental rotation of the rotor 38. Dispensing from the pipette can accordingly be synchronized with the ratcheted rotation of the rotor 38 and controlled via the same microcontroller that controls the motor in the feed station.

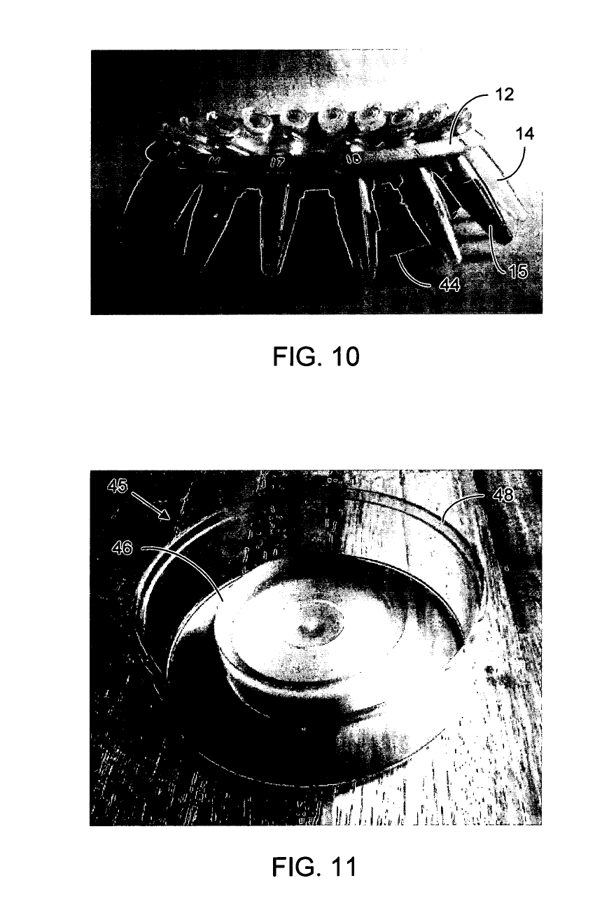

A hollow flotation ring 44 is illustrated in FIGS. 9 and 10. The floatation ring 44 is formed, e.g., of plastic and is sized to fit underneath the test-tube rack 12 so as to be able to support the rack 12 when placed in a bath such that the test tubes 14 will be partially immersed in the bath with the top openings of the test tubes remaining above the liquid level. Again, the test tubes 14 will remain in the same relative positions and orientations in the rack 12 when mounted on the ring 44 as is assumed throughout other stages of processing.

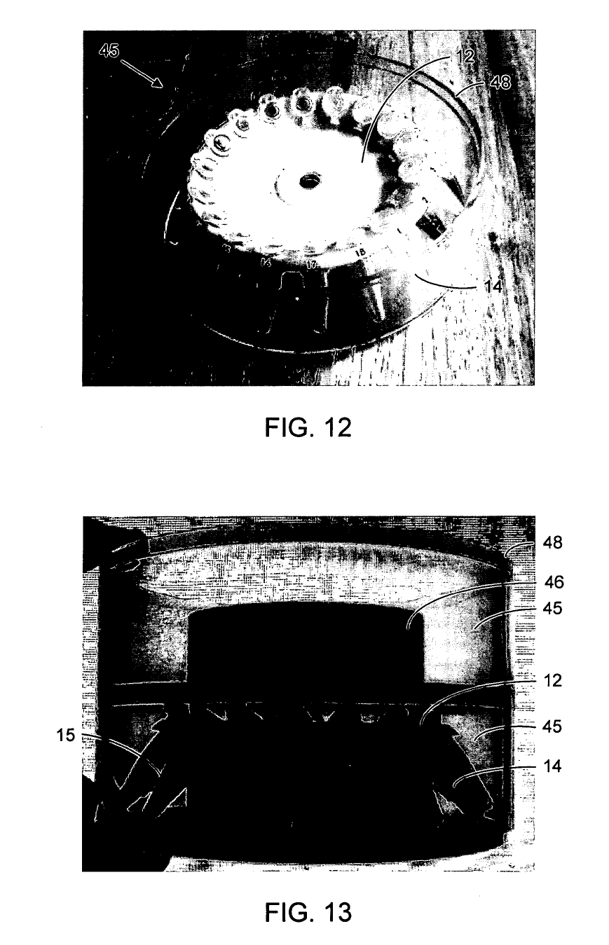

FIGS. 11 and 12 illustrate a holder 45 into which a test-tube rack 12 can be mounted with the test tubes 14 mounted in the apertures of the rack 12 in the same configuration and orientation as when the rack 12 is mounted on the centrifugal spinning vortex induction apparatus 10. Consequently, the positioning and orientation of the test tubes 14 in the rack 12 remain consistent throughout the process. The holder 45 includes a cylindrically shaped inner wall 46 onto which the rack 12 is mounted. The holder 45 further includes a cylindrically shaped outer shell 48 and a void space between the inner wall 46 and outer shell 48. As shown in FIG. 13, a plurality of holders 45, each containing a rack 12 filled with test tubes 14, can be stacked atop each other such that the bottom of one holder 45 serves as a top lid to enclose the holder 45, thereby providing enclosed storage of the test tubes 14 for a desired period of time.

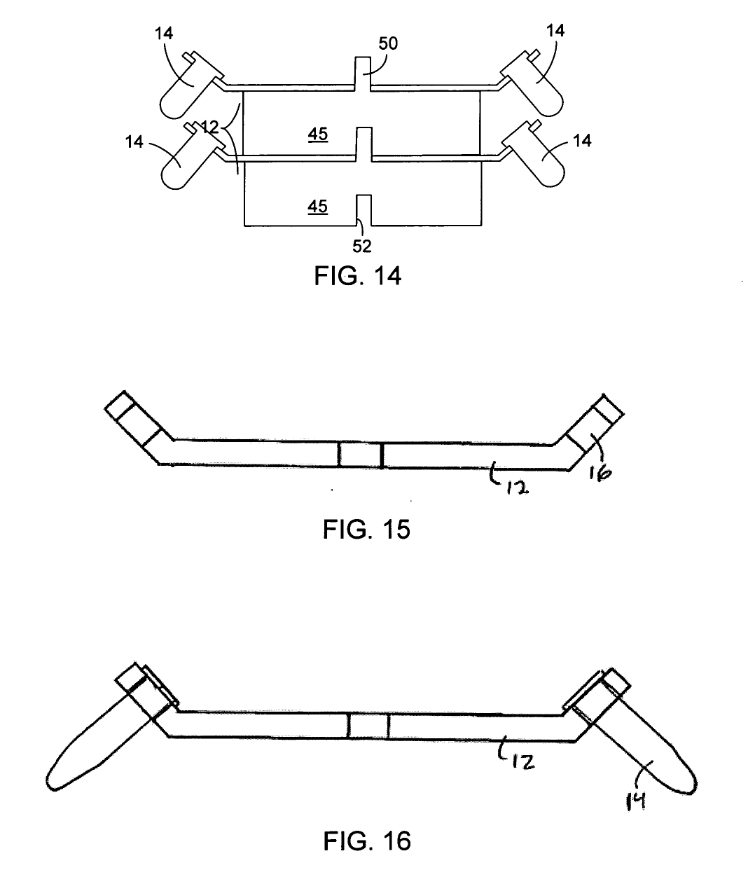

An alternative embodiment of the holder 45 is illustrated in FIG. 14. The holder 45 of FIG. 14, like the previously described holder, is stackable, as is shown. This embodiment of the holder 45 includes a post 50 extending from a top surface of the holder 45 and a cavity 52 embedded into the bottom surface of the holder 45. The post 50 has a diameter sufficiently small to fit through the central aperture 39 of the rack 12. Further, the post 50 and cavity 52 are inversely shaped, such that the post 50 of one holder 45 can fit securely into the cavity of 52 of another holder 45 with a rack 12 mounted on each holder 45 to facilitate stacking.

In an exemplary process, a sample 15 is first pipetted into each test tube 14 while the test tubes 14 are mounted in the test-tube rack 12, which in turn is rotationally mounted on the feed station 36. The test-tube rack 12 is then removed from the feed station 36 without disturbing the relative configuration and orientation of the test tubes 14 in the rack 12, and the rack 12 is then mounted on the centrifugal spinning vortex induction apparatus 10. The rack 12 is locked down, and the cover 30 is closed. The apparatus 10 is then used to rotationally oscillate the rack 12 about its central axis to generate a vortex in each of the test tubes 14 to thereby thoroughly mix the contents of each test tube 14.

Next, the apparatus 10 is used to spin the rack 12 in centrifuge mode to separate components in the samples 15 in each of the test tubes 14. The rack 12 can then be removed from the apparatus 10 and again mounted on the feed station 36, again without disturbing the relative positioning and orientation of the test tubes 14 in the rack 12 during the transition between stations. At the feed station 36, fluids or solids can be added to or withdrawn from the test tubes 14. If, for example, another reactant is then added to the samples 15, the test-tube rack 12 can be again returned to the centrifugal spinning vortex induction apparatus 10 for additional mixing and centrifugation.

The test-tube rack 12 can then be mounted on the flotation ring 44 in a bath to heat or cool the samples 15 in the test tubes 14. The test-tube rack 12 remains in the rack for as long as the temperature regulation is desired (e.g., for as long as is needed to incubate the sample 15 at a controlled temperature). If the samples 15 are to be maintained at an ambient temperature or stored for a given period of time, the rack 12 can be placed in the holder 45, a transition, which again, need not disturb the positioning and orientation of the test tubes 14 in the rack 12.

Various Embodiments of the Test-Tube Rack:

A sectional view of a rigid test-tube rack 12 is provided in FIG. 15. The rigid test-tube rack 12 is not flexed when mounted on a centrifugal spinning vortex induction apparatus or on any other equipment during a sample-preparation procedure. Test tubes 14 are inserted into the rack 12 in FIG. 16. As shown, the walls defining the apertures 16 are oriented such that the inserted test tubes 14 will be oriented such that their longitudinal axes (extending through the base and through the top opening of the test tube and about which the test tube is substantially symmetrical) will be at about 45° from vertical, as shown.

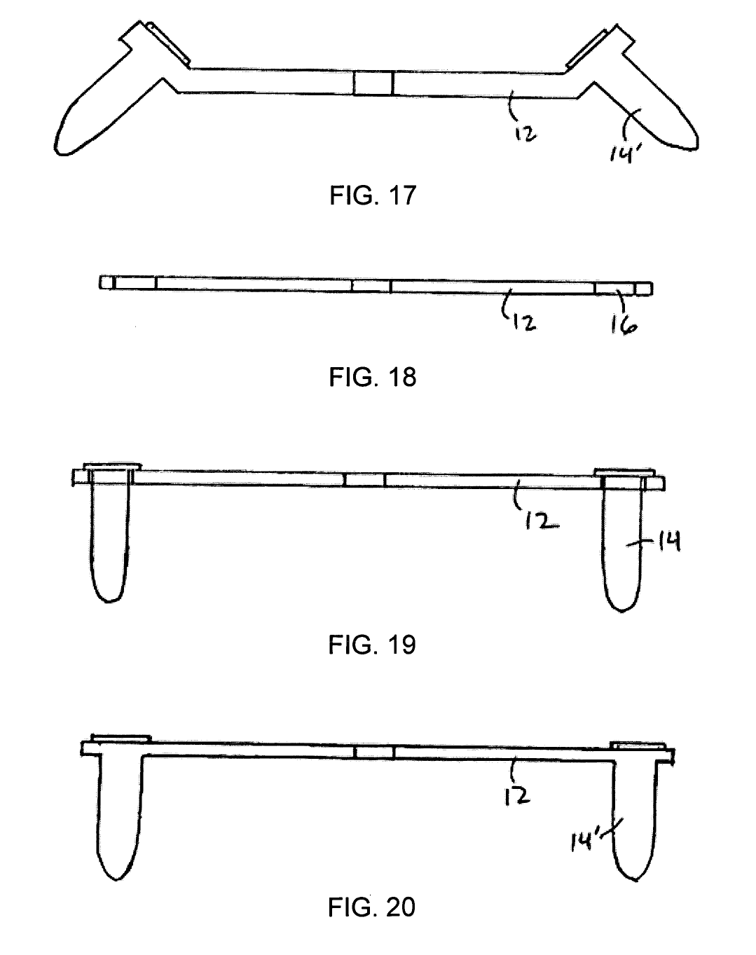

In another embodiment, illustrated in FIG. 17, the test tubes 14′ are integrated with the rack 12 to form a unitary structure. The integrated test tubes 14′ can be formed along with the rack 12 in a single molding operation, wherein the rack 12 and the test tubes 14′ are formed of the same material. Because the test tubes 14′ are integrated with the rack 12, the test tubes 14′ are never removed from the rack 12 and never separately handled, which simplifies processing of the samples in the test tubes 14′.

A sectional view of a flexible test-tube rack 12 is provided in FIGS. 18 and 19. This rack 12 is similar to that of FIGS. 15 and 16, except that the apertures 16 and the inserted test tubes 14 are all vertically oriented when the test tubes 14 are inserted into the rack 12 of FIGS. 18 and 19. The rack 12 of FIG. 20 is identical to that of FIG. 19, except that the test tubes 14′ are integrated with the rack 12 in FIG. 20. The racks 12 of FIGS. 18-20 can all be used with rotors that cause the perimeter of the rack 12 to flex upward so as to tilt the test tubes 14 when the rack 12 is mounted in the rotor.

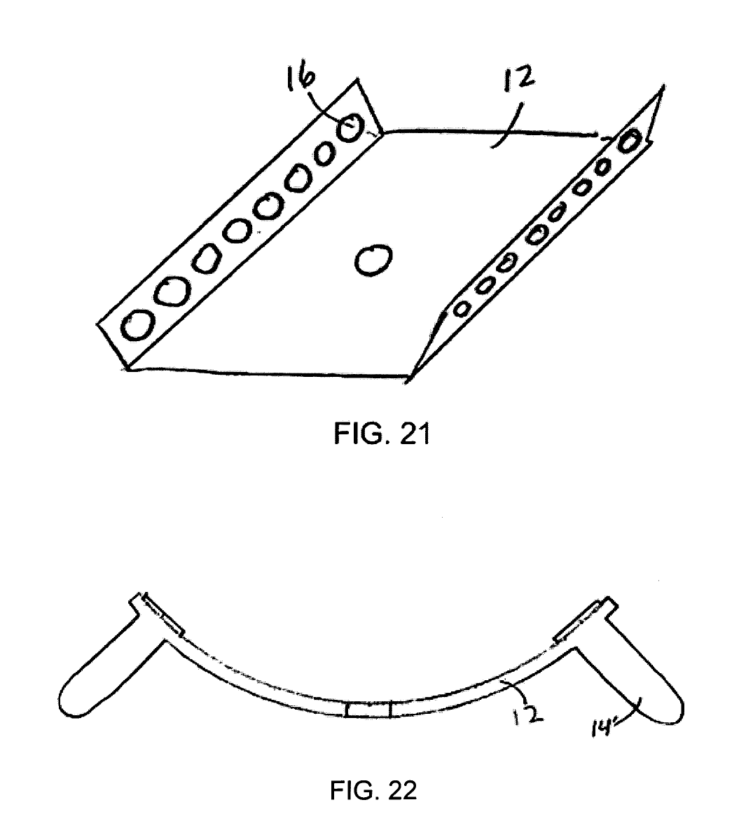

A rigid test-tube rack 12 having a circular configuration (i.e., a round perimeter and a circular ring of test tubes or apertures for the test tubes) along its axes of greatest dimension [i.e., in the plane (typically the horizontal plane) that is orthogonal to the axis about which the drive shaft 20 rotates when the rack 12 is mounted on the centrifugal spinning vortex induction apparatus 10] is shown in FIGS. 1-6, 8, 10 and 12-14. The rack 12, however, need not have this circular configuration. A rack 12 having a rectangular configuration in its plane of greatest dimensions (the dimensions, again, being measured along axes of substantial symmetry) is shown in FIG. 21, wherein the apertures 16 are aligned in at least one pair of parallel rows, the two rows being symmetrical to one another on opposite sides of the center of the rack 12. This rectangular configuration can likewise be adopted for a flexible rack, wherein the flexible rack would have a substantially planar (flat) shape at rest, and the opposite edges that include the apertures can be flexed upward to tilt the test tubes. Moreover, the rectangular configuration can likewise be used with racks in which the test tubes are integrated into the rack, as in the embodiments of FIGS. 17 and 20.

The flexible test-tube rack 12 of FIG. 20 is shown in its flexed position in FIG. 22. The rack is formed of a flexible material (e.g., polypropylene) that enables the perimeter of the rack 12 to be folded upward (as shown in the cross-section of FIG. 22) to form an arc shape. The rack 12 can also/alternatively be made more flexible by reducing the thickness of the rack 12.

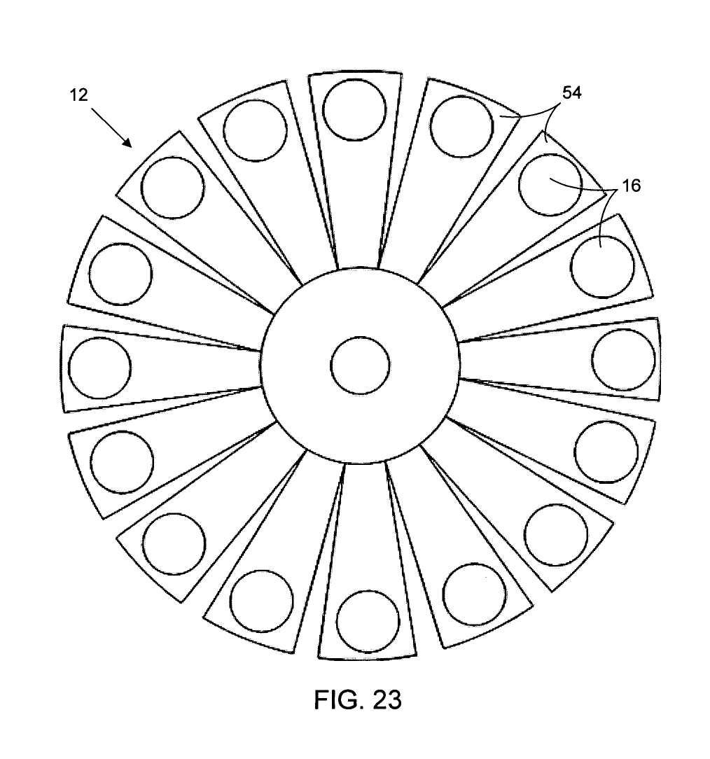

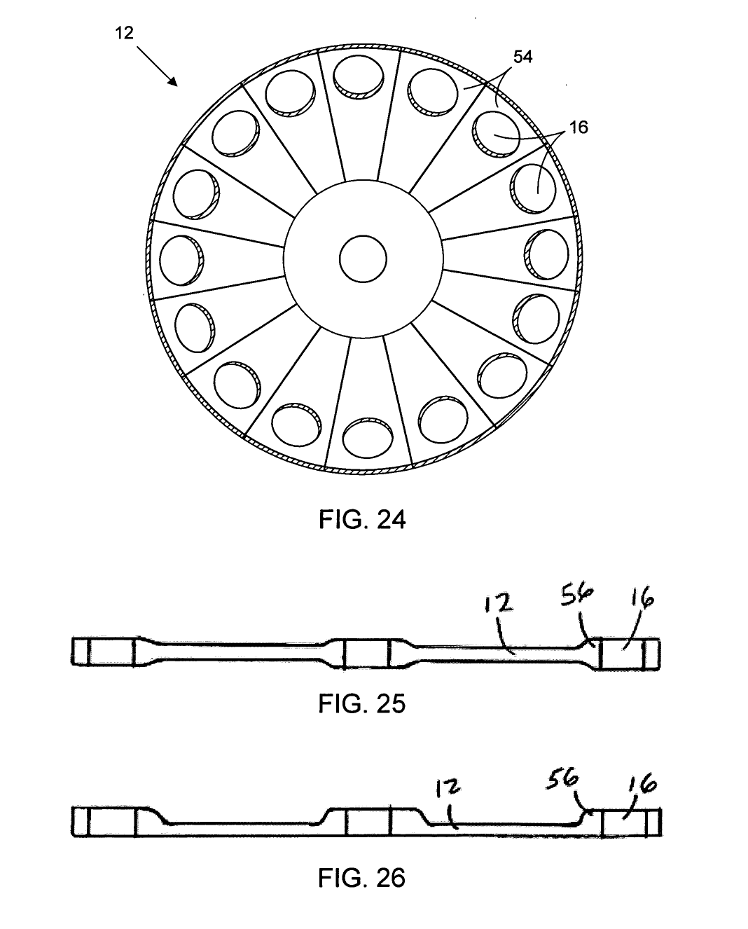

The flexible test-tube rack 12 can have a fan-shaped structure, as shown in FIG. 23, wherein each of the test tubes is mounted (or integrated) toward the end of one of a plurality of strips 54 that radiate outward from the center of the rack 12. The strips 54 are separated by gaps when the rack 12 lies flat (i.e., when not flexed). When the rack 12 is mounted on a rotor of, e.g., a centrifugal spinning vortex induction apparatus the rotor flexes the strips 54 into an arc (as shown in the cross-section of FIG. 22) such that the rack 12 adopts a concave dish shape with the gaps between the strips 54 now closed and with the bases of the test tubes extending outward. A top view of the flexed rack 12 is illustrated in FIG. 24.

To enhance the durability of the rack 12 and to maintain the integrity of the shape of the apertures 16, the rack 12 can include reinforced sections 56 surrounding the apertures 16 for the test tubes as well as around any additional apertures for mounting the rack 12. The reinforcement 56 can be provided by increasing the thickness of the rack 12 around the apertures 16 on one or both sides of the rack 12, as shown in FIGS. 25 and 26.

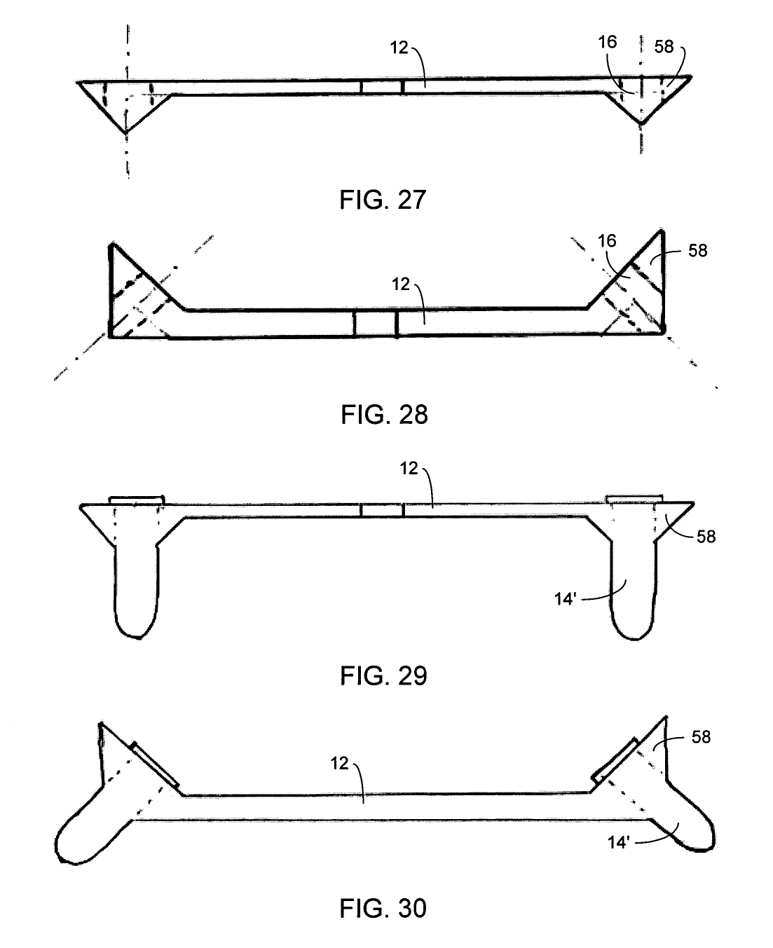

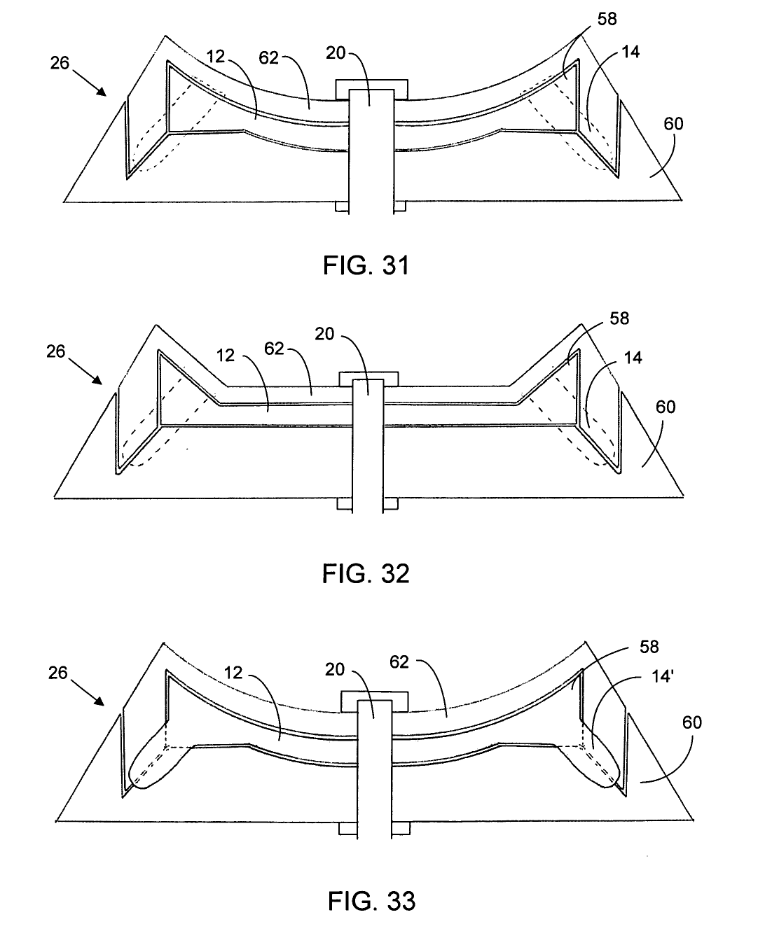

The rack 12 can also be shaped for secure engagement with the rotor on which the rack 12 is mounted. The flexible and rigid racks 12 illustrated in FIGS. 27 and 28 include segments 58 about the apertures 16 that are shaped to fit securely between a base 60 and a cover 62 of a rotor 26 (see FIGS. 31 and 32) and to facilitate stacking of these three elements when the rack 12 is mounted. The flexible and rigid racks 12 of FIGS. 29 and 30 are identical to those of FIGS. 27 and 28, respectively, except that the racks 12 of FIGS. 29 and 30 include integrated test tubes 14′.

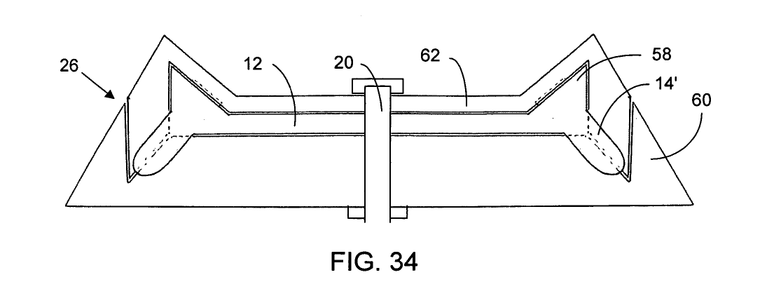

The rack 12 can be mounted on the rotor by first placing the rack 12 on the base 60 of the rotor 26 and then lowering the rotor cover 62 onto the rack 12. The top surface of the base 60 and the interior surfaces of the cover 62 are contoured such that they will contact the outer surfaces of the rack 12 (or be very close—e.g., within a couple mm). As shown, the cover 62 can include surfaces that are nested within surfaces of the base 60 to ensure that the cover 62 is not dislodged during, e.g., centrifugation of the rack 12. Further, as shown in FIGS. 31 and 33, the base 60 and cover 62 of the rotor 26 can include surfaces that are contoured to cause the rack 12 to flex upward at its perimeter as the cover 62 is pressed down onto the rack 12 and secured. When a rack 12 formed of a flexible material, such as polypropylene, is mounted on the rotor 26, the rack 12 is elastically flexed, as shown in FIGS. 31 and 33. Alternatively, the base 60 and cover 62 of the rotor 26 include surfaces that are molds of the surfaces of the rack 12 and test tubes 14/14′, such that the rack 12 is not flexed when mounted, as shown in FIGS. 32 and 34.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various other changes in form and details may be made therein without departing from the scope of the invention.

What is claimed is:

1. A universal test-tube-rack apparatus comprising:
a rack defining a plurality of apertures into which test tubes can be mounted, the apertures being remote from the center of the rack; and
a plurality of test tubes having a closed end and an open end, the test tubes being sized and shaped for mounting in the apertures of the rack.

2. The universal test-tube-rack apparatus of claim 1, wherein the apertures and the test tubes are shaped such that the closed end of the test tubes are further from the center of the rack than are the open ends of the test tubes.

3. The universal test-tube-rack apparatus of claim 1, wherein the rack has a substantially circular cross section in a plane of its greatest dimensions.

4. The universal test-tube-rack apparatus of claim 3, wherein the apertures are radially distributed at a common distance from the center of the rack.

5. The universal test-tube-rack apparatus of claim 1, wherein the rack has a substantially rectangular cross section in a plane of its greatest dimensions.

6. The universal test-tube-rack apparatus of claim 5, wherein the apertures are aligned as two substantially parallel columns on opposite sides of the center of the rack.

7. The universal test-tube-rack apparatus of claim 1, wherein the rack includes a plurality of strips extending radially from the center of the rack, each strip defining at least one of the apertures and being separated by gaps from adjacent strips, each of the strips also being elastically displaceable so as to allow displacement of the test tube(s) mounted in the aperture(s) of that strip.

8. The universal test-tube-rack apparatus of claim 7, wherein the strips can be elastically displaced to a sufficient degree to rotate the orientation of the test tube(s) mounted therein by at least about 45°.

9. The universal test-tube-rack apparatus of claim 1, wherein the test tubes are displaceably mounted in the rack, the apparatus further comprising a chemical or biochemical fluid sample in at least one of the test tubes.

10. The universal test-tube-rack apparatus of claim 9, wherein the sample includes deoxyribonucleic acid and DNA polymerase.

11. A universal test-tube rack, comprising a rack body and a plurality of test tubes extending the through the rack body, the test tubes and the rack body forming an integrated, unitary structure.

12. The universal test-tube rack of claim 1, wherein the apertures and the test tubes are shaped such that the closed end of the test tubes are further from the center of the rack than are the open ends of the test tubes.

13. The universal test-tube rack of claim 1, wherein the rack has a substantially circular cross section in a plane of its greatest dimensions.

14. The universal test-tube rack of claim 13, wherein the apertures are radially distributed at a common distance from the center of the rack.

15. The universal test-tube rack of claim 1, wherein the rack has a substantially rectangular cross section in a plane of its greatest dimensions.

16. The universal test-tube rack of claim 15, wherein the apertures are aligned as two substantially parallel columns on opposite sides of the center of the rack.

17. The universal test-tube rack of claim 11, wherein the rack includes a plurality of strips extending radially from the center of the rack, each strip defining at least one of the apertures and being separated by gaps from adjacent strips, each of the strips also being elastically displaceable so as to allow displacement of the test tube(s) mounted in the aperture(s) of that strip.

18. The universal test-tube rack of claim 17, wherein the strips can be elastically displaced to a sufficient degree to rotate the orientation of the test tube mounted therein by at least about 45°.

19. The universal test-tube rack of claim 11, further comprising a chemical or biochemical fluid sample in at least one of the test tubes.

20. The apparatus of claim 19, wherein the sample includes deoxyribonucleic acid and DNA polymerase.

21. A rotor and rack apparatus for test tubes, the apparatus comprising:
a rotor; and
a rack and a plurality of test tubes, the test tubes extending through the rack, the rack and the test tubes being mounted on the rotor.

22. The apparatus of claim 21, wherein the rotor includes a base and a cover for engaging the rack and test tubes, the rack and the test tubes being mountable between the base and the cover such that each test tube is physically secured in a fixed position relative to the rack.

23. The apparatus of claim 21, wherein the rotor defines grooves or cavities that are sized, shaped and positioned to securely contain the test tubes.

24. The apparatus of claim 21, wherein the test tubes are physically integrated with the rack to form a unitary body.

25. The apparatus of claim 21, wherein the test tubes are distinct from the rack and can be mounted into and removed from the rack.

26. The apparatus of claim 21, wherein the rack includes a plurality of strips extending radially from the center of the rack, each strip defining at least one of the apertures and being separated by gaps from adjacent strips, each of the strips also being elastically displaced by the rotor to mold the strips into a concave configuration, wherein the closed end of the test tubes are positioned further from the center of the rack than are the open ends of the test tubes.

27. The apparatus of claim 26, wherein each strip includes a reinforced segment surrounding each aperture, the reinforced segment having a thickness greater than that of the bulk of the strip.

28. The apparatus of claim 26, wherein each strip can be elastically displaced can be to a sufficient degree to rotate the orientation of the test tube mounted therein by at least about 45°.

29. The apparatus of claim 21, further comprising a chemical or biochemical fluid sample in at least one of the test tubes.

30. The apparatus of claim 29, wherein the sample includes deoxyribonucleic acid and DNA polymerase.

31. The apparatus of claim 21, wherein the rotor has a mass that is larger than the combined mass of the test-tube rack and the test tubes.

32. The apparatus of claim 21, wherein the rotor defines a plurality of cavities in which test tubes can be mounted, the apparatus further comprising an adapter including plungers inserted into the cavities in the rotor, the rack and the test tubes being mounted on the adapter.
